(19) United States
(12) Patent Application Publication
(10) Pub. No.: US 2026/0231065 A1
(43) Pub. Date: Aug. 6, 2026

(54) ACCESS POINT NETWORK SYNCHRONIZATION

(71) Applicant: QUALCOMM Incorporated, San Diego, CA (US)

(72) Inventors: Nicolas GRAUBE, Cambridge (GB); Zhaoming YANG, Shanghai (CN); Tingting LIU, Cambridge (GB); Zaiyong CHEN, Shanghai (CN); Yibo ZHAO, Shanghai (CN); Liuliu ZHAO, Shanghai (CN); Jie ZHANG, Shanghai (CN); Xiuzhuo SHANG, Shanghai (CN); Ziyan ZHANG, Shanghai (CN); Pulong XIE, Shanghai (CN)

(21) Appl. No.: 19/128,809

(22) PCT Filed: Feb. 2, 2023
(86) PCT No.: PCT/CN2023/074201

§ 371 Date: May 9, 2025

(51) Int. Cl. H04W 56/00; H04W 48/20; H04W 52/02; H04W 76/10

(52) U.S. Cl. CPC H04W 56/0015; H04W 48/20; H04W 52/0235; H04W 76/10

(57) ABSTRACT

A method, for coordinating access point synchronization, includes: obtaining at an apparatus, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and transmitting, from the apparatus for a device that is unsynchronized with the second access point, the synchronization signal transmission configuration information and the synchronization signal transfer role indication.

### FIELD OF THE DISCLOSURE

The field of the disclosure is access point network synchronization.

### DESCRIPTION OF RELATED ART

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Networks of devices may be used for various wireless signal transfer applications. For example, networks of devices may transmit positioning signals that may be measured to determine information from which position information (e.g., one or more ranges between a target device and one or more signal sources, a position estimate, etc.) may be determined. As another example, networks of devices may transmit signals containing data and/or communications.

### SUMMARY

An example apparatus, for coordinating access point synchronization, includes: a transceiver; a memory; and a processor, communicatively coupled to the transceiver and the memory, configured to: obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and transmit, via the transceiver for a device that is unsynchronized with the second access point, the synchronization signal transmission configuration information and the synchronization signal transfer role indication.

An example method, for coordinating access point synchronization, includes: obtaining at an apparatus, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and transmitting, from the apparatus for a device that is unsynchronized with the second access point, the synchronization signal transmission configuration information and the synchronization signal transfer role indication.

Another example apparatus, for coordinating access point synchronization, includes: means for obtaining, for first access point of a plurality of access points of a synchronization network, synchronization signal transmission configuration information and, for a second access point of the plurality of access points, a synchronization signal transfer role indication that the second access point of the plurality of access points is a leader, or a follower, or both; and means for transmitting, for a device that is unsynchronized with the second access point, the synchronization signal transmission configuration information and the synchronization signal transfer role indication.

An example non-transitory, processor-readable storage medium includes processor-readable instructions to cause a processor of an apparatus, for coordinating access point synchronization, to: obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and transmit, for a device that is unsynchronized with the second access point, the synchronization signal transmission configuration information and the synchronization signal transfer role indication.

### BRIEF DESCRIPTION OF THE DRAWINGS

FIG. 1 is a simplified diagram of an example communication system.

FIG. 2 is a block diagram of components of an example device shown in FIG. 1.

FIG. 3A is a diagram of discovery and synchronization between access points.

FIG. 3B is a signaling and process flow diagram of discovery and synchronization between access points.

FIG. 4 is a signal timing diagram of handover of a wireless communication device.

FIG. 5 is an example signaling and process flow for coordinating a network of synchronized access points.

FIG. 6 is a timing diagram of periodic advertisement trains of, and listening by, access points.

FIG. 7 is a timing diagram of sub-frames of containing synchronization signals.

FIG. 8 is another timing diagram of sub-frames containing synchronization signals.

FIG. 9 is another example signaling and process flow for coordinating a network of synchronized access points.

FIG. 10 is a timing diagram of synchronization signals used by an observer to determine time drifts.

FIG. 11 is a block flow diagram of a method for coordinating access point synchronization.

### DETAILED DESCRIPTION

Techniques are discussed herein for coordinating access points of an access point synchronization network. For example, a management entity may be used to coordinate additions of access points to a synchronization network and/or to coordinate synchronization of access points in the access point synchronization network. The management entity can select a leader access point for a new access point to follow, and thus listen for a synchronization signal from the leader, to attempt to synch with the leader and thus become a part of the synchronization network and maintain synchronization. The management entity can select the leader based on one or more criteria, e.g., index (number of hops between candidate leaders and a root access point), signal quality of a signal received at candidate leaders from the new access point, etc. The management entity can provide information so that the new access point can follow the selected leader access point, e.g., to help with synchronization of the new access point to the selected leader. As another example, the management entity may provide synchronization signal configuration information to an observer (that may be an access point in the synchronization network or may be a device outside of the synchronization network). The observer may observe synchronization signals from access points in the synchronization network and provide indications of relative time drift between pairs of the access points to the management entity. The management entity can provide the time drifts and/or calibration information to the appropriate access points such that the access points may maintain, and possibly improve, synchronization with the synchronization network (e.g., with respect to a root access point). Other configurations, however, may be used.

Items and/or techniques described herein may provide one or more of the following capabilities, as well as other capabilities not mentioned. Synchronization of access points may be maintained, which may help control signal processing time and/or power (e.g., save processing power and/or time relative to not having synchronized access points). Synchronization of access points may be maintained, e.g., through selection of a leader access point for a follower access point, and/or selection of synchronization signal timing (e.g., sub-frame(s)). Synchronization of access points may be maintained for leader-follower pairs of access points, e.g., with a root access point being the only leader access point, or with multiple leader access points with each of at least one leader access point being at least one hop from the root access point.

Demand, e.g., for communication, may be handed over between synchronized access points, increasing perceived capacity of an access point. A wireless communication device (e.g., an electronic shelf label) may have access to multiple response slots and fast hand-over in case of loss of synchronization with an access point. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as access points. It is expected that standardization for the 5G wireless networks will include support for various positioning methods, which may utilize reference signals transmitted by access points in a manner similar to which LTE wireless networks currently utilize Positioning Reference Signals (PRS) and/or Cell-specific Reference Signals (CRS) for position determination.

Using a wireless network to convey communications and/or data may also be very useful. Transmitting and receive communications and/or data has limitless applications.

Using a synchronized network may help with operation of a wireless network. For example, with synchronized signal transmissions from multiple access points, would-be recipients of the signal may be able to listen for the signal transmissions at specific times, over small windows of time, which may help conserve processing time and/or processing power to receive, measure, decode, and/or interpret the signal transmissions.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

An electronic shelf label (ESL) system may include one or more ESLs that are controlled by a management entity. To facilitate control by the management entity, each ESL may have a wireless connection (e.g., a BLUETOOTH® Low Energy (BLE) connection) to an access point (AP) that is communicatively connected to the management entity (e.g., via the Internet). Thus, commands from the management entity may be wirelessly transmitted to the ESL by the access point.

In some cases, an ESL may be physically moved to a new location. For example, the ESL may be moved from one location in a store (e.g., a particular shelf or a storage area) to a different location. Changing the location of the ESL may result in the ESL losing synchronization with a current access point for the ESL (e.g., due to being out of range), thereby interrupting the management entity's ability to control the ESL and the ESL's ability to report to the management entity. After determining a network outage (e.g., caused by the loss of synchronization), the ESL may perform an onboarding procedure to reestablish synchronization with an access point. To perform the onboarding procedure, the ESL may transmit advertisement messages, receive a connection request from an in-range access point that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisement by one or more ESLs may result in spectral pollution on advertisement channels of the wireless network.

Some techniques and apparatuses described herein enable discovery and synchronization of communication timings of multiple access points in an ESL system. In particular, periodic advertisement timings used by the multiple access points may be synchronized. The multiple access points may use respective, orthogonal hopping frequency sequences (HFSs) to avoid interference among the multiple access points. In some aspects, the HFS used by an access point may be based on an index value (e.g., that indicates a shift relative to a reference HFS), and the ESLs in the ESL system may receive information indicating the respective index values for the multiple access points.

In this way, if an ESL loses synchronization with an access point, then the ESL may search for periodic advertisements of other access points based on the synchronized periodic advertisement timing and on channels indicated by (e.g., derived from) the index values for the multiple access points. In other words, due to the periodic advertisement timings of the multiple access points being synchronized, the time synchronization that the ESL has with the ESL's current access point is also applicable to other access points. Accordingly, the ESL may efficiently detect periodic advertisements of, and establish synchronization with, another access point without performing the full onboarding procedure described above. Moreover, rather than monitoring all channels for periodic advertisements, the ESL may monitor for periodic advertisements only in channels according to the HFSs indicated by the index values. Thus, the techniques described herein conserve radio resources or computing resources (e.g., processor resources, memory resources, and/or battery resources, among other examples) of the ESL and/or the access point, and reduce spectral pollution on the advertisement channels.

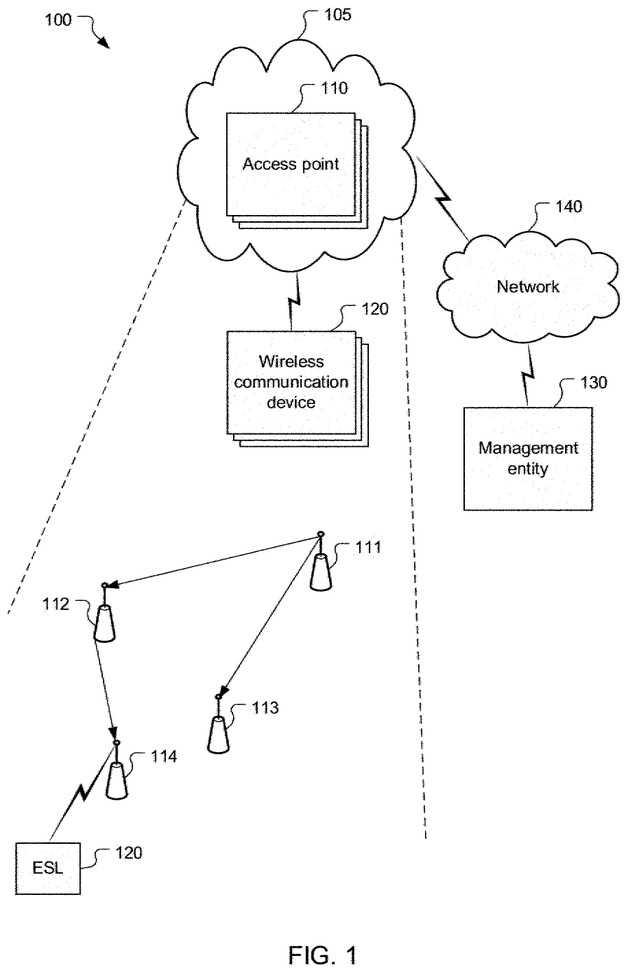

FIG. 1 is a diagram of an example environment 100 in which systems and/or methods described herein may be implemented. As shown in FIG. 1, environment 100 may include at least one access point 110 in a network 105 (e.g., a LAN (Local Area Network), at least one wireless communication device 120, a management entity 130 (ME 130), and a network 140. Devices of the environment 100 may interconnect via wired connections, wireless connections, or a combination of wired and wireless connections. The ME 130 may be hosted in the cloud and accessed via the network 140, e.g., by the APs 110 in the network 105, which is a collective of the APs 110. For example, the network 105 may include a personal area network (e.g., a Bluetooth® network).

The access point 110 may include one or more devices capable of receiving, generating, storing, processing, providing, and/or routing information associated with access point synchronization and/or handover, as described herein. The access point 110 may include a communication device and/or a computing device. The access point 110 may be configured to transmit beacons (e.g., BLE beacons), as well as to scan for and locate other devices (e.g., other devices communicating using BLE protocols). The access point 110 provides a protocol translator to translate between Internet Protocol (IP) and a non-IP protocol.

The wireless communication device 120 may include one or more devices capable of receiving, generating, storing, processing, and/or providing information associated with access point synchronization and/or handover, as described herein. The wireless communication device 120 may include a communication device and/or a computing device. The wireless communication device 120 may be, may include, or may be included in, an ESL.

The management entity 130 may include one or more devices capable of receiving, generating, storing, processing, providing, and/or routing information associated with access point synchronization and/or handover, as described herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. The management entity 130 may include computing hardware used in a cloud computing environment. The management entity 130 may provide control of a system (e.g., an ESL system) that includes the access point(s) 110, the wireless communication device(s) 120, and/or the management entity 130. The access point(s) 110 may be communicatively connected to the management entity 130 via a network (not shown), such as the Internet.

The network 140 may include one or more wireless networks. The network 140 may enable communication among the devices of the environment 100, e.g., providing access to the ME 130 by the APs 110.

The number and arrangement of devices and networks shown in FIG. 1 are provided as an example. In practice, there may be additional devices and/or networks, fewer devices and/or networks, different devices and/or networks, and/or differently arranged devices and/or networks than those shown in FIG. 1. Furthermore, two or more devices shown in FIG. 1 may be implemented within a single device, and/or one or more single devices shown in FIG. 1 may be implemented as multiple, distributed devices. Additionally, or alternatively, a set of devices (e.g., one or more devices) of the environment 100 may perform one or more functions described as being performed by another set of devices of the environment 100.

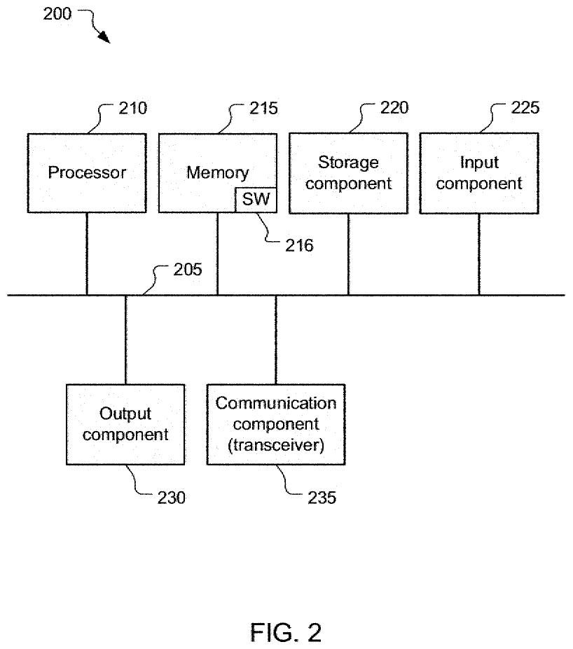

Referring also to FIG. 2, an example device 200, which may correspond to the access point 110, the wireless communication device 120, and/or the management entity 130, may include a bus 205, a processor 210, a memory 215, a storage component 220, an input component 225, an output component 230, and/or a communication component 235. The device 200 may be configured for computation and/or communication. The access point 110, the wireless communication device 120, and/or the ME 130 may include one or more devices 200, and/or one or more components of the device 200.

The bus 205 communicatively couples the processor 210, the memory 215, the storage component 220, the input component 225, the output component 230, and the communication component 235 to facilitate communication among the components of the device 200. The processor 210 may be implemented in hardware, firmware, and/or a combination of hardware and software. The processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 210 may include one or more processors capable of being programmed to perform a function. The memory 215 may include a random access memory (RAM), a read only memory (ROM), and/or another type of dynamic or static storage device (e.g., a flash memory, a magnetic memory, and/or an optical memory) that stores information and/or instructions for use by the processor 210.

The storage component 220 may be configured to store information and/or software related to the operation and use of the device 200. For example, the storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 225 may include one or more components configured to receive information, such as via user input (e.g., a touch screen display, a keyboard, a keypad, a mouse, a button, a switch, and/or a microphone). Additionally, or alternatively, the input component 225 may include one or more components configured to determine a position or a location of the device 200 (e.g., a global positioning system (GPS) or a global navigation satellite system (GNSS)) and/or a sensor configured to sense information (e.g., an accelerometer, a gyroscope, an actuator, or another type of position or environment sensor). The output component 230 may include one or more components configured to provide output information from the device 200 (e.g., a display, a speaker, a haptic feedback component, and/or an audio or visual indicator).

The communication component 235 may include a transceiver and/or a separate receiver and transmitter configured to communicate with other devices, such as via a wired connection, a wireless connection, or a combination of wired and wireless connections. The communication component 235 may be configured to receive information from another device and/or to provide information to another device. For example, the communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

The device 200 may be an ESL. The ESL may include a battery in addition to the aforementioned components. The output component 230 of the ESL may be an electronic paper (e-paper) display or a liquid crystal display (LCD).

The device 200 may be configured to perform one or more processes described herein. The device 200 may be configured to perform these processes based on the processor 210 executing software instructions stored by a non-transitory computer-readable medium, such as the memory 215 and/or the storage component 220. A computer-readable medium is defined herein as a non-transitory memory device. A memory device may include memory space within a single physical storage device or memory space spread across multiple physical storage devices.

Software instructions may be read into the memory 215 and/or the storage component 220 from another computer-readable medium or from another device via the communication component 235. When executed, software instructions stored in the memory 215 and/or the storage component 220 may cause the processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The device 200 may include means for performing one or more processes described herein and/or means for performing one or more operations of the processes described herein. The device 200 may include means for detecting a periodic advertisement broadcast from an access point; means for transmitting, to the access point and based on detecting the periodic advertisement, a message to initiate a connection between the access point and device 200; means for receiving, from the access point, a synchronization message that identifies at least one of a periodic advertisement timing used by the access point or a set of index values that includes at least a first index value associated with the access point, the first index value indicating a first hopping frequency sequence used by the access point; means for transmitting periodic advertisements synchronized with the periodic advertisement timing used by the access point and according to a second hopping frequency sequence that is based at least in part on a second index value associated with the device 200, the second hopping frequency sequence being orthogonal to the first hopping frequency sequence; or the like. The device 200 may include means for transmitting periodic advertisements; means for receiving, from an access point that detected one or more of the periodic advertisements, a message to initiate a connection between the device 200 and the access point; means for transmitting, to the access point, a synchronization message that identifies at least one of a periodic advertisement timing used by the device 200 or a set of index values that includes at least an index value associated with the device 200, the index value indicating a hopping frequency sequence used by the device 200; or the like. The device 200 may include means for receiving, from a plurality of access points, respective messages indicating detection of a periodic advertisement from an access point, the plurality of access points associated with respective index values indicating hopping frequency sequences used by the plurality of access points; means for determining, for the access point, a leader access point, from among the plurality of access points, and an index value indicating a hopping frequency sequence, the hopping frequency sequence being orthogonal to each of the hopping frequency sequences used by the plurality of access points; means for transmitting, to the leader access point, information that identifies the access point and the index value; or the like. The device 200 may include means for receiving information identifying a set of index values respectively associated with a plurality of access points, the set of index values indicating hopping frequency sequences used by the plurality of access points; means for detecting that synchronization between the device 200 and an access point, of the plurality of access points, has been lost; means for monitoring for periodic advertisements, broadcast from at least one additional access point of the plurality of access points, according to the hopping frequency sequences indicated by the set of index values; means for detecting a periodic advertisement broadcast from an additional access point, of the plurality of access points, based at least in part on monitoring for periodic advertisements; or the like. Such means may include one or more components of the device 200 described in connection with FIG. 2, such as the bus 205, the processor 210, the memory 215, the storage component 220, the input component 225, the output component 230, and/or the communication component 235.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

The description herein may refer to the processor 210 performing a function, but this includes other implementations such as where the processor 210 executes software (stored in the memory 215) and/or firmware. The description herein may refer to the device 200 performing a function as shorthand for one or more appropriate components (e.g., the processor 210 and the memory 215) of the device 200 performing the function. The description herein may refer to the processor 210 performing a function as shorthand for the device 200 performing the function.

The memory 215 may be a non-transitory storage medium that may include random access memory (RAM), flash memory, disc memory, and/or read-only memory (ROM), etc. The memory 215 may store software 216 which may be processor-readable, processor-executable software code containing instructions that may be configured to, when executed, cause the processor 210 to perform various functions described herein. Alternatively, the software 216 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The processor 210 may include a memory with stored instructions in addition to and/or instead of the memory 215.

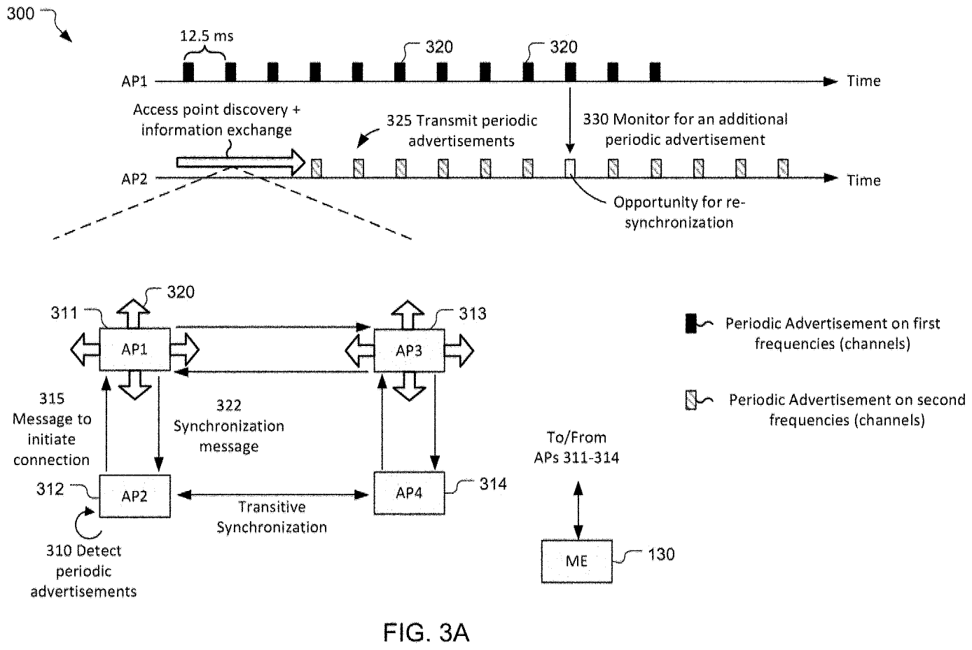

Referring also to FIG. 3A, a signaling environment 300 may be used for discovery and synchronization between access points. As shown, the environment 300 may include multiple access points 311, 312, 313, 314 (e.g., access points 110) (labeled as AP1, AP2, AP3, AP4). The access points 311-314 may each be communicatively connected to a management entity (e.g., the management entity 130). The access points 311-314 and/or the ME 130 may be included in a wireless communication system, such as an ESL system. The wireless communication system may use a wireless communication technology, such as BLE.

As used herein, “transmission timing” or “periodic advertisement timing” refers to a timing or schedule by which a device (e.g., an access point) transmits communications or periodic advertisements. For example, two devices that use (e.g., that are synchronized to) the same periodic advertisement timing may transmit periodic advertisements concurrently.

The access point 311 may transmit (e.g., broadcast) periodic advertisements 320 (e.g., a train of periodic advertisements). The periodic advertisements 320 may be unidirectional broadcast messages. The access point 311 may transmit periodic advertisements in accordance with a periodic advertisement with multiple response (PAwMR) schedule. Moreover, the access point 311 may transmit the periodic advertisements 320 using a first HFS. The first HFS may be an HFS configured for the access point AP1 (e.g., if the access point AP1 is not a follower of another access point), or the first HFS may be shifted from a reference HFS based at least in part on a first index value associated with (e.g., selected by) the access point AP1.

An access point (AP2) may detect 310 at least one periodic advertisement 320 broadcast from the access point AP1 (e.g., by scanning known channels on which the access point AP1 performs transmissions and/or by scanning, or taking a snapshot of, an entire band). That is, the access point AP2 may discover the access point AP1. The access point AP2 may listen on one or more advertisement channels (e.g., legacy advertisement channels) to detect information that enables the access point AP2 to follow and synchronize with the access point AP1, thereby enabling the access point AP2 to monitor for the periodic advertisement(s). The access point AP2 may monitor for (e.g., listen for) and detect the periodic advertisement(s) 320 prior to initiation of periodic advertisement transmissions by the access point AP2 (which may be referred to as a “detect before proceed” policy). For example, in a boot sequence during starting (or re-starting) of the access point AP2, the access point AP2 may listen for periodic advertisements from other access points before starting periodic advertisement transmissions. Access points (e.g., isolated access points), such as the access point AP2, may periodically listen for periodic advertisements from neighboring access points.

Based on detecting a periodic advertisement from the access point AP1, the access point AP2 may transmit, and the access point AP1 may receive, a message 315 (e.g., an unsolicited message) to initiate a connection between the access point AP1 and the access point AP2. Following the connection, or as part of the connection procedure, the access point AP1 may transmit, and the access point AP2 may receive, a synchronization message 322. The synchronization message 322 may identify the periodic advertisement timing (e.g., the PawMR schedule) used by the access point AP1. For example, the synchronization message may include PAST information that indicates the periodic advertising timing used by the access point AP1 (e.g., by indicating a time offset used by the access point AP1). In addition, or alternatively, the synchronization message may identify the first HFS used by the access point AP1. For example, the PAST information may indicate a reference HFS used by the access point AP1, and the first HFS may be the reference HFS or an HFS that is shifted (e.g., frequency shifted) from the reference HFS. For example, if an HFS is shifted from a reference HFS, then at all frequency instances in a frequency sequence, a channel index of the HFS is different from a channel index of the reference HFS. The synchronization message 322 may identify the first HFS used by the access point AP1 by indicating the first index value associated with the access point AP1 (e.g., the first HFS may be determined using the first index value and the reference HFS). For example, the synchronization message 322 may indicate a set of index values that includes the first index value and/or one or more additional index values, associated with additional access points, known to the access point AP1. The set of index values may include an index value for the access point AP2 that indicates an HFS to be used by the access point AP2.

The transfer of periodic advertising timing information (e.g., the transfer of PAST information) may enable the access point AP2 to synchronize with the access point AP1. Accordingly, in the same manner, multiple additional access points may synchronize to the same periodic advertisement timing. For example, access point AP3 may also synchronize with access point AP1, and access point AP4 may synchronize with access point AP3 (thereby resulting in access point AP4 being synchronized with access point AP2 by transitive synchronization). In this way, multiple access points may become time synchronized with each other.

Based on receiving the synchronization message 322, the access point AP2 may transmit periodic advertisements 325 (e.g., transmissions on a data channel) synchronized with the periodic advertisement timing (e.g., the PAwMR schedule) used by the access point AP1. In this way, periodic advertisements are transmitted concurrently by the access point AP1 and the access point AP2.

The access point AP2 may transmit the periodic advertisements according to a second HFS. The second HFS may be offset from (e.g., orthogonal to) the first HFS used by the access point AP1 or a reference HFS. In other words, each of the access points (e.g., with physically overlapping coverage areas) may use an HFS that is orthogonal to an HFS of any of the other access points. By using orthogonal HFSs, interference among the access points may be avoided despite the access points being time synchronized.

The second HFS may be based at least in part on a second index value (e.g., different from the first index value) associated with the access point AP2. For example, each of the access points (e.g., with physically overlapping coverage areas) may be associated with a different index value from any of the other access points. Accordingly, based at least in part on the set of index values identified to the access point AP2, the access point AP2 may select the second index value to achieve an HFS (e.g., in a radio frequency range of the access point AP2) that is orthogonal to every other HFS currently in use. The second HFS may be shifted relative to the first HFS or the reference HFS based at least in part on the second index value. For example, the second HFS may be determined according to:

$${HFS}_{i} = ( {HFS}_{0} + {index}_{i} ) mod 37 \qquad ( 1 )$$

where HFS₀ is the reference HFS, HFSᵢ is the HFS being determined, index; is the index value used to determine the HFS, and mod is the modulo operation. Equation (1) uses a value of 37 for the modulo operation because a BLE system uses 37 data channels. However, a different value for the modulo operation may be used (e.g., corresponding to a quantity of channels), e.g., in other systems.

An index value may indicate an HFS in a manner other than as described above. An index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

The access point AP1 may transmit, and one or more wireless communication devices (e.g., wireless communication devices 120) may receive, information identifying the periodic advertisement timing (e.g., PAST information) used by the access point AP1. For example, the access point AP1 may transmit the information in connection with onboarding the wireless communication device(s) to the access point AP1. The access point AP2 may transmit, and one or more wireless communication devices (e.g., the wireless communication devices 120) may receive, information identifying the periodic advertisement timing (e.g., PAST information) used by the access point AP2. For example, the access point AP2 may transmit the information to wireless communication devices already onboarded with the access point AP2, or the access point AP2 may cause the wireless communication devices to repeat an onboarding procedure with the access point AP2 during which the information is transmitted.

The access point AP1 may transmit (e.g., via broadcast), and one or more wireless communication devices (e.g., the wireless communication devices 120) synchronized to the access point AP1 may receive, information identifying a set of (e.g., one or more) index values indicating HFSs used by one or more access points. For example, the set of index values may include the first index value associated with the access point AP1, the second index value associated with the access point AP2, and/or one or more additional index values, associated with additional access points, known to the access point AP1. Similarly, in some aspects, the access point AP2 may transmit (e.g., via broadcast), and one or more wireless communication devices (e.g., the wireless communication devices 120) synchronized to the access point AP2 may receive, information identifying a set of (e.g., one or more) index values indicating HFSs used by one or more access points. For example, the one or more index values may include the first index value associated with the access point AP1, the second index value associated with the access point AP2, and/or one or more additional index values, associated with additional access points, known to the access point AP2. The access point AP1 and/or the access point AP1 may receive, from the management entity 130, information indicating the index values that are in use (e.g., valid indexes) for one or more additional access points.

Over time (e.g., due to clock drift), the periodic advertisement timing used by the access point AP1 and the access point AP2 may become misaligned. The access point AP2 may monitor 330 (e.g., sporadically) for an additional periodic advertisement from the access point AP1 in a monitoring opportunity. In other words, the access point AP2 may sacrifice a periodic advertisement transmission (e.g., for a particular group of wireless communication devices) in order to monitor for the additional periodic advertisement from the access point AP1. The monitoring opportunity, in which the access point AP2 monitors for the additional periodic advertisement, may be based at least in part on an expected clock drift between the access point AP1 and the access point AP2. Based on a timing of the additional periodic advertisement, the periodic advertisement timing may be realigned between the access point AP1 and the access point AP2. For example, the access point AP2 may realign with the periodic advertisement timing used by the access point AP1 based at least in part on a timing of the additional periodic advertisement (e.g., based at least in part on a difference between the actual timing of the additional periodic advertisement and an expected timing of the additional periodic advertisement).

An access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point.

Thus, in this example, the second access point is both a leader access point and a follower access point.

FIG. 3A is provided as an example. Other examples may differ from what is described with respect to FIG. 3A.

FIG. 3B is a signaling and process flow 350 associated with discovery and synchronization between access points. As shown, the flow 350 includes signal transfer to and from multiple access points 351, 352, 353, 354 (AP1, AP2, AP3, AP4), e.g., access points 110), and the management entity 130. The access points 351-354 may each be communicatively connected to the management entity 130. The access points 351-354 and/or the management entity 130 may be included in a wireless communication system, such as an ESL system. The wireless communication system may use a wireless communication technology, such as BLE.

The access point 354 may transmit, and the management entity 130 may receive, a registration message 355. The registration message 355 may indicate an identity of the access point 354 (e.g., a BD_ADDR or other information sufficient for the management entity 130 to identify the access point 354). The access point 354 may transmit the registration message 355 based at least in part on the access point 354 being unsynchronized with any other access point. For example, the access point 354 may be a new access point to the wireless communication system or may have lost a previous synchronization.

At stage 360, the access point 354 may transmit periodic advertisements 361, 362, 363, and the access points 351-353 may, respectively, detect one or more of the periodic advertisements 361-363. The access point 354 may transmit the periodic advertisements 361-363 in a similar manner as described above. The periodic advertisements 361-363 may indicate an identity of the access point 354 (e.g., a BD_ADDR).

Also at stage 360, based on detecting the periodic advertisements 361-363, the access points 351-353 may transmit, and the management entity 130 may receive, respective messages 366, 367, 368 indicating detection of a periodic advertisement from the access point 354. The messages 366-368 may indicate an identity of the access point 354 (e.g., from which a periodic advertisement was detected). Additionally, or alternatively, the messages 366-368 may indicate a signal strength between the respective access point 351-353 and the access point 354. For example, the messages 366-368 may include a respective received signal strength indication (RSSI).

At stage 370, the management entity 130 may determine (e.g., select) a leader access point, from among the access points 351-353, for the access point 354. For example, the management entity 130 may compare signal strengths reported by the access points 351-353 and the management entity 130 may select the access point 351-353 that reported the best signal strength (e.g., the highest RSSI) as the leader access point for the access point 354.

At stage 375, the management entity 130 may determine an index value indicating an HFS that is to be used by the access point 354. For example, the access points 351-353 may be associated with respective index values indicating HFSs used by the access points 351-353 (e.g., where an HFS is orthogonal to each of the other HFSs), and the management entity 130 may determine an index value for the access point 354 that is different from each of the index values associated with the access points 351-353. In other words, the index value determined for the access point 354 may indicate an HFS that is orthogonal to each of the HFSs used by the access points 351-353. An index value may indicate an HFS in a similar manner as described in connection with FIG. 3A.

At stage 380, the management entity 130 may transmit, and the determined leader access point (AP2, as shown) may receive, a follower message 382 including information (e.g., a synchronization message) that identifies the access point 354, indicates that the leader access point AP2 is to lead, and/or indicates the index value determined for the access point 354 by the management entity 130. The management entity 130 may transmit this information to cause the leader access point 352 to establish a connection with the access point 354. The leader access point 352 may transmit, and the access point 354 may receive, a message 385 to initiate a connection between the leader access point 352 and the access point 354, and the leader access point 352 and the access point 354 may establish the connection.

Following the connection, or as part of the connection procedure, the leader access point 352 may transmit, and the access point 354 may receive, a synchronization message 390 that identifies the periodic advertisement timing (e.g., the PAwMR schedule) used by the leader access point 352 (e.g., PAST information) and/or a set of index values, as described herein. The set of index values may include index values associated with the access points 351-353 (e.g., the index values indicate HFSs used by the access points 351-353). Additionally or alternatively, the set of index values may include the index value determined for the access point 354 by the management entity 130. Based on receiving the synchronization message, the access point 354 may transmit periodic advertisements (e.g., a periodic advertisement train) synchronized with the periodic advertisement timing used by the leader access point 352 and using an HFS indicated by the index value.

FIG. 3B is provided as an example. Other examples may differ from what is described with respect to FIG. 3B.

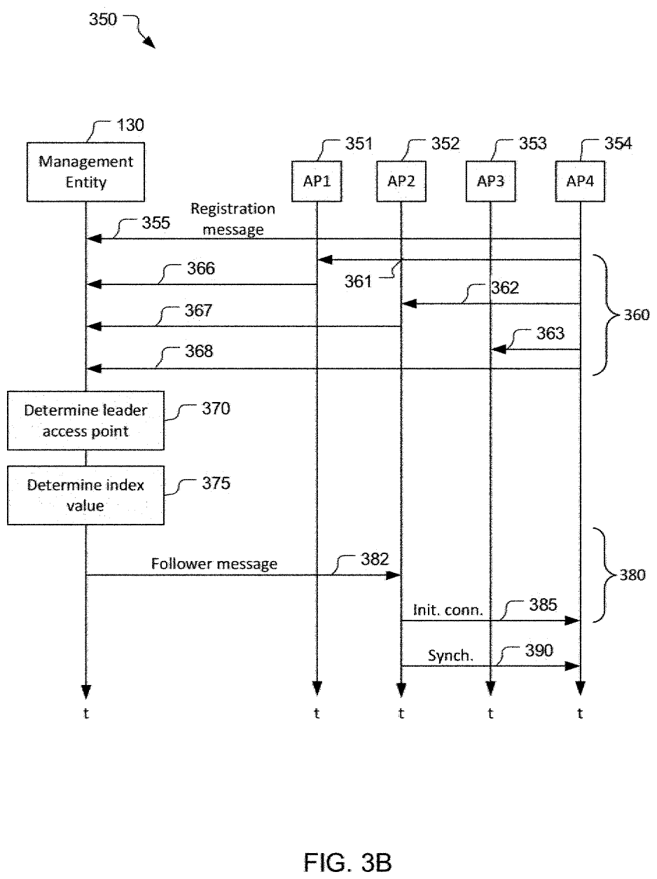

FIG. 4 is a timing diagram 400 associated with handover of a wireless communication device. As shown, the diagram 400 includes signals from multiple access points 401, 402 (e.g., access points 110), shown as a first access point (AP1) and a second access point (AP2), and at least one wireless communication device 403 (e.g., wireless communication device 120). The access points 401, 402 and the wireless communication device 403 may be included in a wireless communication system, such as an ESL system. The wireless communication system may use a wireless communication technology, such as BLE. The wireless communication device 403 may be, or may include, or may be included in, an ESL.

The wireless communication device 403 may be included in a wireless communication device group. Wireless communication devices of the wireless communication device group may monitor for periodic advertisements, from an access point with which the wireless communication devices are synchronized, in periodic intervals that are less frequent than a frequency at which the periodic advertisements are transmitted by the access point. For example, the wireless communication devices of the wireless communication device group may monitor for periodic advertisements every 1.6 seconds, whereas the access point may transmit the periodic advertisements every 12.5 milliseconds (ms). Accordingly, the wireless communication devices may enter a sleep state or another type of low power state for a portion of the periodic interval in which the wireless communication devices are not monitoring for periodic advertisements. A first periodic advertisement transmission of a cycle may be monitored by a first wireless communication device group, a second periodic advertisement transmission of a cycle (e.g., occurring 12.5 ms after the first periodic advertisement transmission) may be monitored by a second wireless communication device group, and so forth. A periodic advertisement timing of the access points may be synchronized, as described in connection with FIG. 3A and/or FIG. 3B.

The wireless communication device 403 and the first access point 401 may have established synchronization prior to operations shown in FIG. 4. Accordingly, the wireless communication device 403 may receive, from the first access point 401, information identifying the periodic advertisement timing (e.g., PAST information) and information identifying a set of index values (e.g., a plurality of index values) respectively associated with multiple access points (e.g., including the first access point 401 and/or the second access point 402), as described in connection with FIG. 3A, prior to operations shown in FIG. 4. For example, the set of index values may indicate HFSs used by the access points 401, 402.

The wireless communication device 403 may detect, e.g., at a time 405, that synchronization between the wireless communication device 403 and the first access point 401 (e.g., the one access point associated with the wireless communication device 403 and for which the wireless communication device 403 monitors periodic advertisements) has been lost. Based on detecting that synchronization has been lost, the wireless communication device 403 may monitor 410 for periodic advertisements broadcast from one or more additional access points, such as the second access point 402. Due to the time coordination of the access points 401, 402, the wireless communication device 403 may not need additional information relating to the periodic advertisement timing of the access points 401, 402 in order to monitor for periodic advertisements. Accordingly, the wireless communication device 403 may monitor for the periodic advertisements from one or more additional access points according to the same periodic advertisement timing used by the first access point 401. In this way, the wireless communication device 403 may efficiently identify an additional access point and quickly engage with the additional access point to enter into an association with the additional access point.

The wireless communication device 403 may monitor for the periodic advertisements (e.g., in one or more channels) according to the HFSs indicated by the set of index values. For example, for each index value, the wireless communication device 403 may determine an HFS based at least in part on the index value (as described in connection with FIG. 3A). Continuing with the example, the wireless communication device 403 may monitor for periodic advertisements in channels indicated by the HFS. The HFSs for the plurality of access points may be time aligned. However, at any given time, each of the HFSs may use a different channel from any of the other HFSs to avoid interference.

To monitor for periodic advertisements, the wireless communication device 403 may search for periodic advertisements in one or more time periods designated for the wireless communication device group that includes the wireless communication device 403. However, searching by the wireless communication device 403 may not be limited to those time periods. For example, the wireless communication device 403 may monitor for periodic advertisements in a first time period associated with periodic advertisement monitoring for a first wireless communication device group that includes the wireless communication device 403 and in a second time period associated with periodic advertisement monitoring for a second wireless communication device group that does not include the wireless communication device 403. Accordingly, the wireless communication device 403 may monitor for periodic advertisements in sub-frame intervals (e.g., 12.5 ms intervals).

Based on monitoring for periodic advertisements, the wireless communication device 403 may detect a periodic advertisement 415 (e.g., a periodic advertisement train) broadcast from the second access point 402. The wireless communication device 403 may detect periodic advertisements from multiple access points, and the wireless communication device 403 may select (e.g., based on signal strength measurements associated with the periodic advertisements or another metric) the second access point 402 from among multiple access points.

Based on detecting the periodic advertisement 415 from the second access point 402, the wireless communication device 403 may transmit, and the second access point 402 may receive, a first message 420 to initiate handover of the wireless communication device 403 to the second access point 402. The first message 420 may indicate, to the second access point 402, the presence of the wireless communication device 403. For example, the first message 420 may indicate an identity of the wireless communication device 403 (e.g., a BD_ADDR or other information sufficient for the second access point 402 to identify the wireless communication device 403). The wireless communication device 403 may transmit the first message 420 in a response slot (e.g., of the PAwMR train of the second access point 402) reserved by the second access point 402 for such first messages. The first message 420 may be an unsolicited message. The first message 420 may not be encrypted. The wireless communication device 403 may transmit the first message 420 one or more times (e.g., the wireless communication device 403 may repeat transmission of the first message 420) until the wireless communication device 403 has been onboarded to the second access point 402 (or another access point).

Based on successful reception of the first message 420 by the second access point 402, the second access point 402 may transmit, and the wireless communication device 403 may receive, a second message 425 (e.g., an AUX_CONNECT_REQ message) to establish synchronization between the wireless communication device 403 and the second access point 402. Thus, synchronization between the wireless communication device 403 and the second access point 402 may be established independently of (e.g., without use of) broadcasting on advertisement channels. In other words, the synchronization may be established independently of (e.g., without use of) the full onboarding procedure described above. The second access point 402 may transmit the second message 425 in a transmission opportunity (e.g., for transmitting such second messages) that is fixed. In this way, the wireless communication device 403 may be onboarded to the second access point 402 using a lightweight and efficient procedure. The first message 420 and/or the second message 425 may include an exchange of security elements (e.g., security credentials) between the wireless communication device 403 and the second access point 402.

FIG. 4 is provided as an example. Other examples may differ from what is described with respect to FIG. 4.

Referring in particular again to FIG. 1, depending on the topology of the access points 110, significant drift may be present between the access points 110, e.g., between one or more follower access points and a root access point. Further, if none of the access points have a clock relationship, then no common time reference or common frequency drift will exist. As shown in FIG. 1, an example network of access points includes a root access point 111, and follower access points 112, 113, 114. Follower access points, e.g., the access point 114, with more hops to the root access point 111 may have larger time drifts relative to the root access point 111 than access points, e.g., the access points 112, 113, with fewer hops to the root access point 111. If an access point is to join the access points 111-114, then this access point may have difficulty determining which of the access points 111-114 to use as a leader access point by listening to periodic advertisement (PA) transmissions from the access points 111-114. The PA transmissions may not have enough information upon which to determine the best access point to use as a leader, e.g., number of hops from an access point to the root access point, slot to select for synchronization, etc. Access points following the same leader may listen for a transmission from the leader during the same time window (e.g., sub-frame), which may help control the respective drift in a similar manner and make coordination by the management entity 130 simpler, although different follower access points may listen (e.g., under control of the management entity 130) during different time windows for transmissions from the same leader. The arrangement of the access points in a network, e.g., the access points 111-114, and to which access point a follower access point (e.g., an access point that is new to the network, e.g., due to having lost synchronization with the network, being newly introduced to the network, etc.) uses as a leader access point (with the follower access point syncing to the leader access point) will affect the time drift variation against the root access point seen by the follower access point. For example, if the follower access point can synchronize to the leader access point soon after the leader access point syncs with a leader of the leader access point, then the time drift at the follower access point may be kept low. For example, the time drift may be kept as low as possible if the follower access point (e.g., the access point 114) syncs to the leader access point (e.g., the access point 112) at the next possible opportunity (e.g., at the next PA transmission by the leader access point) after the leader access point (e.g., the access point 112) syncs with the leader (e.g., the access point 111) of the leader access point (e.g., the access point 112).

The management entity 130 may be used to coordinate the topology of the network of the access points 110 (or other access point network), e.g., to help access points in the network have low time drifts. For example, the management entity 130 may be configured to select access points to be used as leader access points and/or follower access points to attempt to find the most appropriate topology, e.g., to attempt to have the lowest time drifts possible. The management entity 130 may select access points as leaders and/or followers based on numbers of hops (which may be referred to as an index or HFS (Hopping Frequency Sequence)) to the root access point of different possible topologies. The management entity 130 may determine synchronization mapping for the network and distribute appropriate information and/or instructions to the access points of the network to implement a desired topology.

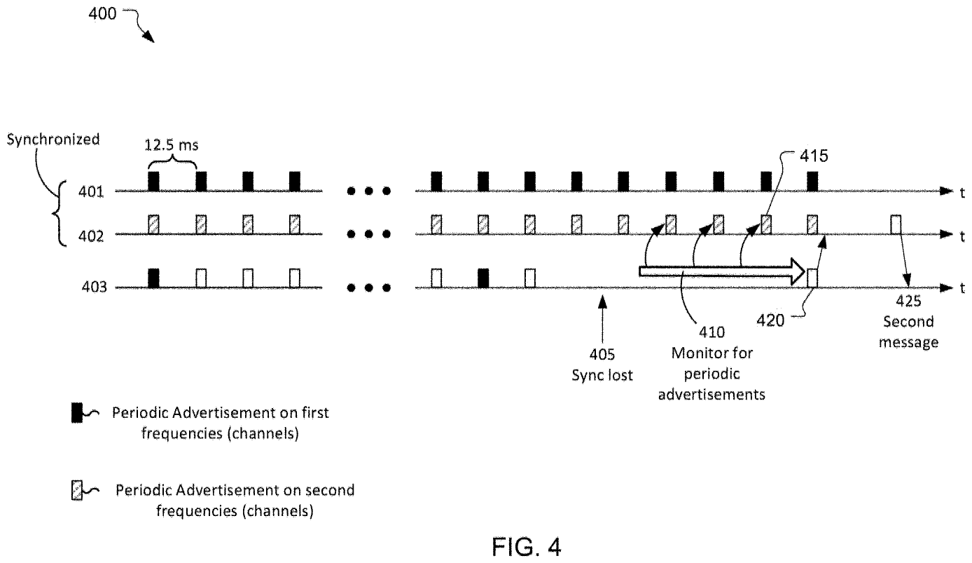

Referring to FIG. 5, with further reference to FIGS. 1-4, a signaling and process flow 500 for coordinating a network of synchronized access points includes the stages shown. In the flow 500, signals are transferred between the management entity 130 and access points 501, 502, 503, 504 (e.g., the access points 111-114). In the flow 500, the AP 501 is a root access point, the access points 502, 503 are synced to the access point 501, and the access point 504 is unsynchronized (initially) with any of the access points 501-503. The flow 500 is an example, as one or more stages may be added, removed, and/or rearranged, and/or two or more stages combined.

At stage 510, the access point 504 registers with the management entity 130. The access point 504 transmits a register message 512 to the management entity 130 and the management entity 130 replies by transmitting an enable message 514 to the access point 504. The enable message 514 may include configuration information for the access point 504 to use to establish a connection with the ME 130.

At stage 520, the access point 504 may transmit one or more WUPs (Wake-Up Packets) 521, 522, 523 (and/or one or more other non-connectable packets) to the access points 501-503, respectively. The WUPs 521-523 may be broadcast and received by any entity that is listening. The access point 504, at this time, is not synchronized with any of the access points 501-503, with the access points 501-503 being in a “synchronized” network in that the access points 502, 503 directly or indirectly use signal transmissions (e.g., PAwMR) to calibrate timing of signal transmissions from the access points 502, 503, respectively. The access point 504 may not be synchronized with any of the access points 501-503 for a variety of reasons, e.g., due to a cold reset, a warm reset, a loss of synchronization (e.g., moving out of range of an access point with which the access point 504 was synchronized), etc. The access point 504 may continue to transmit WUPs while the access point 504 is not synchronized. The access points 501-503 may transmit report messages 526, 527, 528, respectively, reporting the received WUPs to the management entity 130.

At stage 530, the management entity 130 may determine and indicate a leader access point from the access points 501-503 to serve as a leader access point for the access point 504, and of which the access point 504 will be a follower access point. The management entity 130 may have knowledge of the access point network that may be used in combination with information about the WUPs 521-523 to select an access point as a leader access point for the access point 504. For example, the management entity 130 may know synchronization signal transfer roles of the access points in the network (i.e., whether each access point is a leader, a follower, or both, and which leader access point each follower access point follows), numbers of hops from each access point to the root access point, access points that received a WUP from an unsynchronized access point, signal quality of received WUPs, a PA transmission used by each follower access point to synch with a respective leader access point, and synchronization signal transmission configuration information (e.g., synchronization signal transmission timing). The management entity 130 may know an access point identity of each access point in the network, an access address of each access point in the network, and channel map information (per access point) that the management entity 130 may use to determine an HFS that may be used, for example, to facilitate or enable quick handover of a device (e.g., the UE 110 such as an ESL) between access points. The HFS may define times at which, and the channels over which, the access points 501-503 will transmit periodic advertisements. The management entity 130 may obtain the knowledge of the access point network, e.g., synchronization signal transmission configuration information and synchronization signal transfer roles (e.g., leader access points, follower access points, leader-follower pairs) by assigning such information, determining such information over time (e.g., adding information according to the flow 500), and/or retrieving such information from the memory 215 (e.g., having been provided and stored in the memory 215), etc.

At sub-stage 532, the management entity 130 may determine which access point to serve as a leader access point for the presently-unsynchronized access point using one or more criteria. For example, the management entity 130 may select, from the access points that received a WUP from the access point 504, the access point that has the fewest hops to the root access point 501. If the root access point 501 received a WUP from the access point 504, then the root access point 501 may be selected to be a leader for the access point 504. As another example, referring in particular to FIG. 1, the access points 112, 113 may receive a WUP from a new access point 114 while the access point 111 does not. As another example of selection criteria, the management entity 130 may consider a received signal strength of a WUP. For example, if there are multiple access points that receive a WUP from an unsynchronized access point, then the management entity 130 may select, from among the multiple access points, the access point that received the respective WUP with the highest signal strength. For example, if the access points 112, 113 both receive a WUP from a new access point 114, and a signal strength of the WUP received by the access point 112 is stronger than a signal strength of the WUP received by the access point 113, then the management entity 130 may select the access point 112 to be a leader for the new access point 114.

The management entity 130 may determine configuration information for the access point 504 to synchronize to the selected leader access point. The configuration information may include an orthogonal offset, an access address for HFS channel calculation, and a sub-frame to listen to for a synchronization signal, e.g., for synchronizing or re-aligning.

The management entity 130 may determine a time window (e.g., sub-frame) for the access point 504 to use to synchronize to the leader access point. For example, the access points 501-503 may transmit PA trains with frames of signals, with each frame comprising sub-frames. The management entity 130 may determine which sub-frame of the selected leader access point for the follower access point, in this example the access point 504, to use for syncing to the leader access point (e.g., during which to listen for and determine the timing of leader access point transmission). The follower access point may listen during the specified sub-frame for the PA train signal, determine a time of arrival of the signal from the leader access point, and use the time of arrival and a locally-calculated timing for the sub-frame to determine a delta time. The follower access point may use the determined delta time to determine timing of transmissions by the follower, e.g., to attempt to transmit a PA train and/or communication signals and/or other signals with the same timing as (in synchronization with) the leader access point. With the access points of the network doing this in combination, the network is a “synchronized” network, with signal transmissions being simultaneous or nearly so.

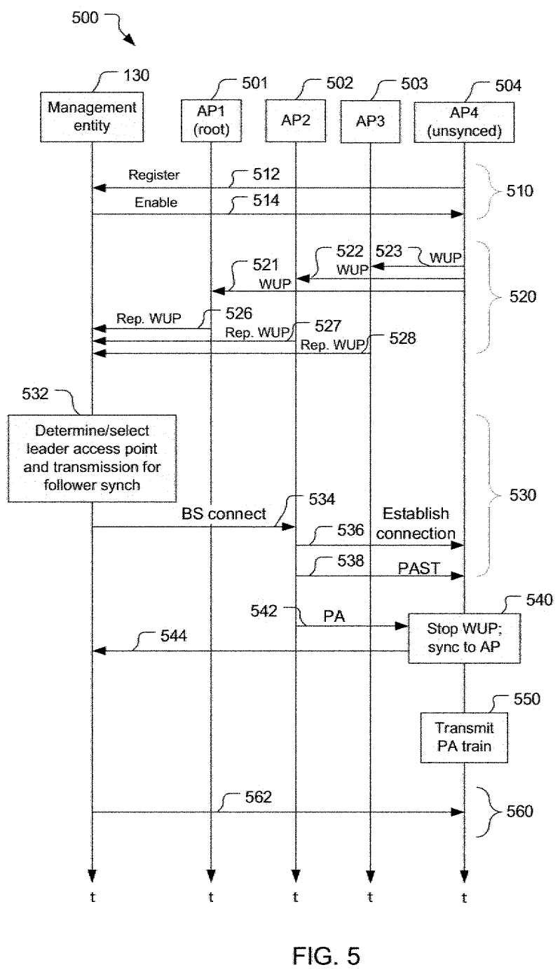

The ME 130 may determine the time window for the access point 504 to use to listen to a signal from the leader access point to synchronize to the leader access point where there is a chain of access points to the root access point. For a chain of access points to the root access point (i.e., where there at least two hops from an access point to the root access point), then there will be at least one access point that is both a leader and a follower. For example, the access point 112 is a follower of the access point 111 and a leader for the access point 114. The root access point 111 is thus a leader of a leader (i.e., a leader of the access point 112 which is a leader of the access point 114). The ME 130 may determine which sub-frame for each follower to use to listen for the PA train of a respective leader to use for syncing. For example, the ME 130 may try to have the follower synchronize to the leader of the follower as soon as possible after the leader synced to the leader of the leader. For example, referring also to FIG. 6, the access points 501-504 (e.g., the access points 111-114) may transmit respective PA trains 610, 611, 612, 613, 614 each comprising respective sub-frames. Consecutive sub-frame transmissions in each of the PA trains 610-614 are separated by a time spacing 600 of 12.5 ms. Consequently, an air log for the synchronization network (including the access point 504 once added to the network) may indicate that there are regular 12.5 ms transmissions on different data channels across the access points. The ME 130 may instruct the access points 502, 503 to listen for a third sub-frame transmission 620 (listen at corresponding sub-frames 621, 623) to synchronize to the root access point 501 and may instruct the access point 504 (that follows the access point 502) to listen for a fourth sub-frame transmission 630 (listen at a corresponding sub-frame 622) to synchronize to the access point 502. The ME 130 could instruct the access point 504 to use a later sub-frame to synchronize to the access point 502. Instructing the access point 504 to use the sub-frame that is closest in time and after the sub-frame used by the access point 502 to synchronize to the root access point 501 (i.e., the next sub-frame of the leader after the sub-frame used by the leader to synchronize to the leader of the leader), however, may help reduce (e.g., minimize) the time drift of the access point 504. Sub-frame transmissions (including, but not limited to, the sub-frame transmissions 620, 630), may or may not contain substantive content (e.g., data), but provide a signal that may be used for synchronizing, e.g., determining time of signal arrival at a device which may be used to determine when to transmit by that device. Multiple followers (e.g., the access points 112, 113) of the same leader (e.g., the access point 111) may listen during the same window of time (e.g., the sub-frames 621, 623) in order to use the same sub-frame transmission, in this example the sub-frame transmission 620, to synchronize to the leader. This may help keep timing drift small at the followers, and keep the timing drift consistent for multiple followers.

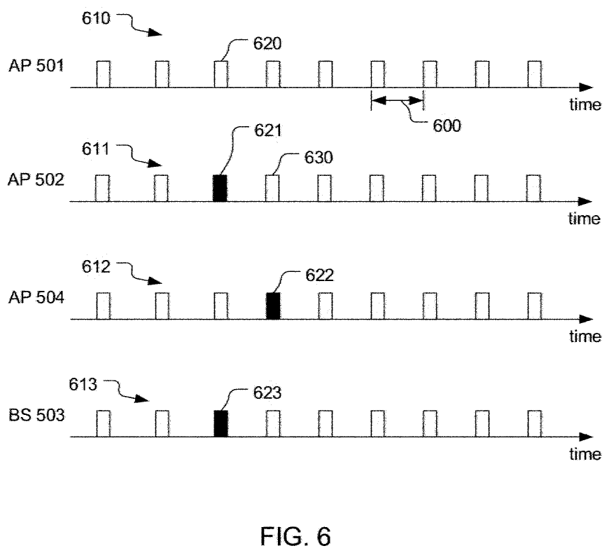

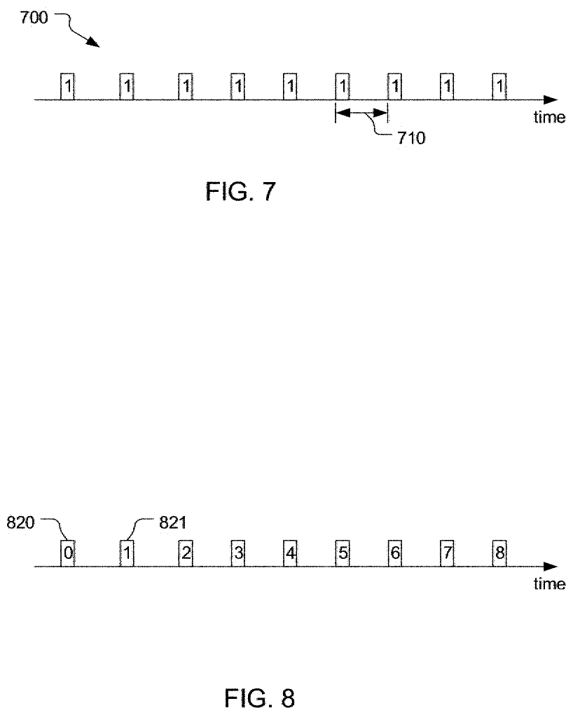

The ME 130 may assign fixed or variable signal transmission times (e.g., fixed or variable sub-frames containing signal transmissions) to follower access points to listen for the signal transmissions to synchronize with a leader access point. For example, referring also to FIG. 7, the ME 130 may assign a fixed (i.e., the same) sub-frame, in this example the sub-frame “1”, in each frame to be used by a follower access point to listen for a transmission by a leader access point in order to synchronize with the leader access point. The same sub-frame transmitted in consecutive frames in a PA train 700 are separated by a time spacing 710 of 1.6 s. As another example, referring also to FIG. 8, the ME 130 may assign different (varying) sub-frames in different frames to be used by a follower access point to listen for a transmission from a leader access point. In the example shown in FIG. 8, in frame the number of the sub-frame used for synchronization signaling is increased by one in each consecutive frame. Thus, in this example, in a first frame, the follower access point listens during sub-frame 820 (with a sub-frame index of “0”), and in a second frame, the follower access point listens during sub-frame 821 (with a sub-frame index of “1”), and so on. The leader access point will transmit during each sub-frame other than the sub-frame(s) during which the leader access point is listening for a signal from a leader of the leader. Numerous other techniques, with or without a pattern of sub-frame indexes and/or with or without applying a formula, may be used to assign different sub-frames to synchronization signals in different frames. A frame contains 128 sub-frames, and the ME 130 may be configured to assign any of the 128 sub-frames for synchronization signal listening. Varying the sub-frame for scanning/listening for a synchronization signal may reduce the likelihood of a follower access point (e.g., the access point 114) listening for a synchronization signal from a leader (e.g., the access point 112) during a time that the leader is listening for a synchronization signal from a leader (e.g., the access point 111) of the leader. Also, as an access point cannot listen and advertise during the same sub-frame, varying the sub-frame in different frames allows an access point to listen on a sub-frame during one frame and advertise during that sub-frame in a different frame. In this way, a sub-frame need not be sacrificed in order to onboard a communication device, e.g., an ESL.

The ME 130 may transmit an access point connection message 534 to the access point 502 (the access point selected to serve as a leader access point for the presently-unsynchronized access point). The message 534 may include a timing of a synchronization signal such as an indication of a sub-frame (e.g., an indication of a fixed sub-frame or an indication (e.g., a formula) for a variable sub-frame) for the access point 504 to use to listen for a synchronization signal from the access point 502 to determine time drift (relative to the access point 502) and corresponding time drift calibration in order to synchronize to the access point 502. The access point 502 may respond to receiving the message 534 by transmitting an establish connection message 536 to the access point 504 (the presently unsynchronized access point). Using the connection with the access point 504, the access point 502 may transmit PAST signals 538 to the access point 504, with the PAST signals 538 including information for the access point 504 to synchronize with the access point 502. The connection between the access points 502, 504 may be established in a manner other than discussed herein, and the connection used to transfer PAST information between the access points 502, 504 such that one, or both, of the access points 502, 504 can synchronize to the other access point 502, 504.

At stage 540, the access point 504 may synchronize to the access point 502 and stop transmitting WUP signals. For example, the access point 504 may respond to receiving the PAST signals 538 from the access point 502 by stopping to send the WUPs 521-523. The access point 504 may use information from the PAST signals 538 to synchronize with a PA train 542 transmitted by the access point 502. The access point 504 may use a PA received by the access point 502 to synchronize with the access point 502 as discussed herein. The access point 504 may transmit an air log that may indicate that an access point with a PA train that is not time aligned with one or more access points of a synchronization network sends WUPs and later stops sending WUPs and has the PA train time aligned with at least one other access point of the synchronization network. The access point 504 may transmit a synchronize message 544 indicating that the access point 504 is synchronized with the access point 502.

At stage 550, with the access point 504 being synchronized with the access point 502, the access point 504 may transmit a PA train. The access point 504 may resynchronize with the access point 502 repeatedly, e.g., upon one or more (e.g., every) synchronization signal sub-frame indicated in the configuration information of the message 536. The PA train may be used for any of a variety of purposes, e.g., to transmit signals to an entity such as the wireless communication device 120. The transmitted signals may be communication signals, data signals, positioning signals, etc. The wireless communication device 120 may, for example, use one or more received positioning signals to determine position information (e.g., a range to a signal source, a position estimate, etc.). As another example, the wireless communication device 120 may receive and process communication signals as appropriate, e.g., to provide one or more indications of visual and/or audible notices to a user interface.

At stage 560, the management entity 130 may change a synchronization configuration. For example, the management entity 130 may transmit a configuration change message 562 indicating to change a sub-frame for a synchronization signal, to change a clock offset, etc.

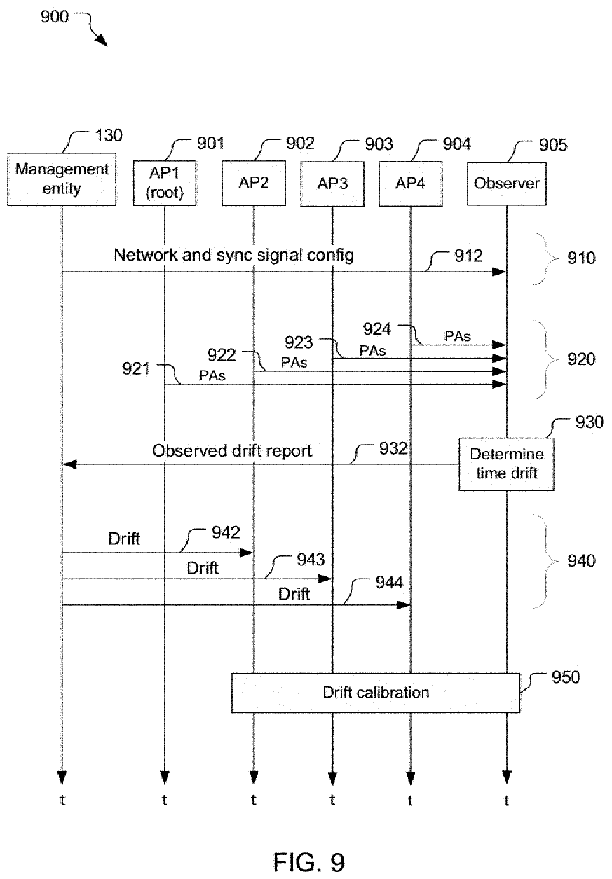

Referring to FIG. 9, with further reference to FIGS. 1-4 and 10, a signaling and process flow 900 for coordinating a network of synchronized access points includes the stages shown. In the flow 900, signals are transferred between access points 901, 902, 903, 904 and an observer 905, between the observer 905 and the management entity 130, and between the management entity 130 and the access points 902-904. The observer 905 may be an example of the device 200 such as an access point, the wireless communication device 120, or another device. In the flow 900, the AP 901 is a root access point. The flow 900 is an example, as one or more stages may be added, removed, and/or rearranged, and/or two or more stages combined. The flow 900 may be performed in addition to or instead of the flow 500 shown in FIG. 5. For example, the flow 900 may be performed after adding an access point to a synchronized access point network according to the flow 500.

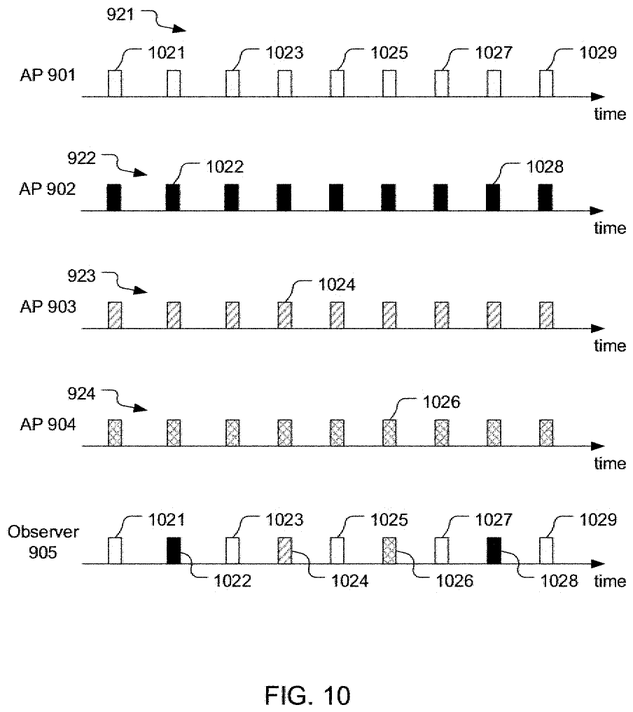

At stage 910, the management entity 130 may transmit a network and synchronization signal configuration message 912 to the observer 905. The message 912 may include synchronization signal configuration information that may include configuration information for at least one synchronization signal to be transmitted by at least one of the access points 901-904. For example, the synchronization signal configuration information may include configuration information for a synchronization signal to be transmitted by the root access point 901 and one or more synchronization signals to be transmitted by one or more of the access points 902-904. For example, the synchronization signal configuration information may include configuration information for a synchronization signal (e.g., multiple transmission of the synchronization signal) to be transmitted by the root access point 901 and synchronization signals (e.g., multiple transmissions of each of the synchronization signals) to be transmitted by the access points 902-904. The message 912 may include synchronization network information such as synchronization signal transfer role of each access point in the synchronization network, or at least an indication of a root access point (i.e., the leader of the synchronization network). The observer 905 may use this information to determine which access point is the root access point, and thus which access points are followers, and/or which access points are leaders and which are followers. The observer 905 may use this information to determine for which pairs of access points to determine relative timings. The example discussed with respect to FIGS. 9 and 10 is for determining relative time drifts of each non-root access point relative to the root access point, but relative timings may be determined for leader-follower pairs even if one or both of the access points in the access point pair is/are not the root access point.

At stage 920, the access points 901-904 may transmit respective PA trains 921, 922, 923, 924. Each of the PA trains 922-924 may be synchronized to the PA train 921, although there may be some drift between the PA train 921 and the PA trains 922-924, and the amount of drift may be proportional to the number of hops between the root access point 901 and an access point under consideration. The observer 905 may listen for and measure (e.g., time of arrival (ToA) of) PAs of the respective PA trains 921-924. The observer 905 may vary for which of the PA trains 921-924 that the observer listens, e.g., to reduce drift between a measured PA of the PA train 921 of the root access point 901 and a respective one of the measured PAs of a respective one of the PA trains 922-924. For example, in the example shown in FIG. 10, the observer 905 may measure a PA of one of the PA trains 922-924 in a next available synch signal sub-frame after measurement of a PA of the PA train 921 from the root access point 901. Also in the example shown in FIG. 10, the observer 905 may alternate between measuring a PA of the PA train 921 and a PA of one the PA trains 922-924, with the PA trains 922-924 varied in a round-robin fashion. Thus, in this example, the observer 905 may measure a PA 1021 (during a respective sub-frame) of the PA train 921, then a PA 1022 of the PA train 922, then a PA 1023 of the PA train 921, then a PA 1024 of the PA train 923, then a PA 1025 of the PA train 921, then a PA 1026 of the PA train 924, then a PA 1027 of the PA train 921, then a PA 1028 of the PA train 922, then a PA 1029 of the PA train 921, etc. While PA trains are used as an example, any synchronization signal transmissions may be used.

At stage 930, the observer 905 may determine and report time drift of the access points 902-904 relative to the access point 901. For each pair of measured PAs (or other synchronization signals), with one PA from the PA train of the root access point (here the PA train 921), and one PA from a respective one of the PA trains from a non-root access point (here the PA trains 922-924), the observer 905 may determine an observed time drift (e.g., an offset in time of arrival of the PA from the root access point 901 and the time of arrival of the PA from the non-root access point, minus a separation time between transmission of the PA from the root access point 901 and transmission of the PA from the non-root access point). The observer 905 may transmit an observed drift report 932 to the management entity 130 that includes the observed time drift for each of the access points 902-904 relative to the root access point 901.

At stage 940, the management entity 130 may transmit one or more of the observed time drifts to the respective access points 902-904. The management entity 130 may send a drift report 942 to the access point 902 with the observed time drift of the access point 902 relative to the root access point 901 (i.e., the time drift of arrival of synchronization signals at the observer 905 from the access points 901, 902, respectively). Similarly, the management entity 130 may send a drift report 943 to the access point 902 with the observed time drift of the access point 903 relative to the root access point 901 and/or may send a drift report 944 to the access point 904 with the observed time drift of the access point 903 relative to the root access point 901. Also or alternatively, the management entity 130 may use the time drift information to determine calibration information, e.g., transmission timing adjustment, for one or more of the access points 902-904. The calibration information may be included in the respective drift reports 942-944 in addition to or instead of the respective observed time drift.

At stage 950, one or more of the access points 902-904 may use the respective time drift and/or calibration information received from the management entity 130 to calibrate signal transmission by the respective access point 902-904. The time drift (offset) and/or calibration information reported by the management entity 130 may be used by the respective non-root access point 902-904 to calibrate transmission timing to help synchronize signal transmissions by the respective access point 902-904 to help the access points 901-904 provide a synchronized network of access points, with signal transmissions synchronized, or nearly so.

As seen from FIGS. 5 and 9 and the corresponding description, the management entity 130 may be configured for coordinating access point synchronization. For example, the processor 210 of the ME 130 may be configured to obtain, for each of a plurality of first access points of a synchronization network, synchronization signal transmission configuration information and a synchronization signal transfer role indication. The synchronization signal transfer role indication may indicate whether a particular access point is a leader, a follower (and which leader the follower follows), or both. As another example, the processor 210 of the ME 130 may be configured to transmit, for a device, the synchronization signal transmission configuration information for at least one synchronization signal corresponding to at least one of the plurality of first access points with which the device is unsynchronized. The synchronization signal transmission configuration information may, for example, be synchronization signal timing information and/or calibration information and may be used by an access point to calibrate future signal transmission timing. As another example, the synchronization signal transmission configuration information (e.g., synchronization signal timing information) may be used by an observer device to listen for synchronization signals such that the observer can determine relative synchronization signal timing (e.g., of an access point relative to a root access point), and report the relative synchronization signal timing to the management entity 130.

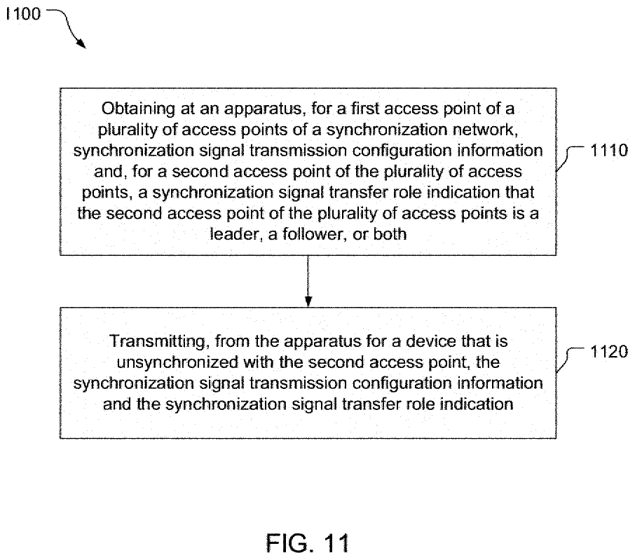

Referring to FIG. 11, with further reference to FIGS. 1-10, a method 1100 for coordinating access point synchronization includes the stages shown. The method 1100 is, however, an example and not limiting. The method 1100 may be altered, e.g., by having one or more stages added, removed, rearranged, combined, performed concurrently, and/or having one or more single stages split into multiple stages.

At stage 1110, the method 1100 includes obtaining at an apparatus, for a first access point of a plurality of access points of a synchronization network, synchronization signal transmission configuration information and, for a second access point of the plurality of access points, a synchronization signal transfer role indication that the second access point of the plurality of access points is a leader, or a follower, or both. For example, the management entity 130 may assign leader status and/or follower status to an access point as part of a process of forming a synchronization network (e.g., selecting access points for a new network or adding the access point to an existing network to form a “new” network (a network with a different member set than the existing network)). The processor 210 may obtain the synchronization signal transfer role indication by retrieving the synchronization signal transfer role indication from the memory 215, e.g., having been assigned and stored by the processor 210, or having been otherwise received (e.g., via the communication component 235 (e.g., a transceiver)) and stored by the processor 210. The synchronization signal transfer role indication may be obtained for each of the access points of the network or for one or more of the access points of the network (e.g., a leader synchronization signal transfer role indication for the root access point with or without obtaining the synchronization signal transfer role indication of any other access point in the synchronization network). For the synchronization signal transmission configuration information, the management entity 130 may assign a synchronization signal configuration (e.g., timing), e.g., at sub-stage 532, or may receive synchronization signal transmission configuration information (e.g., observed drift in the observed drift report 932) for each of the access points in a synchronization network (e.g., the access points 501-503 or the access points 901-904). The processor 210, possibly in combination with the memory 215, possibly in combination with a transceiver (e.g., of the communication component 235) may comprise means for obtaining the synchronization signal transmission configuration information and the synchronization signal transfer role indication.

At stage 1120, the method 1100 includes transmitting, from the apparatus for a device that is unsynchronized with the second access point, the synchronization signal transmission configuration information and the synchronization signal transfer role indication. For example, the management entity 130 may transmit the access point connection message 534 with synchronization signal transfer role indication indicating a leader access point (e.g., the access point 502) and a new follower access point (e.g., the access point 504) in a synchronization network and synchronization signal configuration information, e.g., timing of a synchronization signal by the leader access point and/or calibration information for signal transmission by the follower access point. The synchronization signal transmission configuration information may include, e.g., timing of synchronization signal transmission by the leader access point and/or the follower access point, and/or transmission calibration information for the follower access point. The access point 504 may use this information to calibrate timing (e.g., to reduce drift relative to the leader and thus to the root access point) of signal transmissions (e.g., by applying calibration information, or determining signal transmission timing of a synchronization signal by the leader access point and determining calibration information therefrom). As another example, the management entity 130 may transmit the drift reports 942-944 to the observer 905 including the configurations of synchronization signals from the access points 901-904 and at least the status of the access point 901 as a leader and possibly indications of leader and/or follower status of each of the access points 902-904 and, for a follower, which access point the follower follows. The processor 210, possibly in combination with the memory 215, possibly in combination with a transceiver (e.g., of the communication component 235) may comprise means for transmitting the synchronization signal transmission configuration information and the synchronization signal transfer role indication. By providing the synchronization signal transmission configuration information and the synchronization signal transfer role indication, a new follower access point may become part of a synchronization network, which may help reduce processing time and power for receiving and processing signals transmitted by members of the synchronization network. Also or alternatively, providing the synchronization signal transmission configuration information and the synchronization signal transfer role indication to an observer may help the observer provide timing information for access points in a synchronization network that can be distributed to appropriate access points to help the network maintain, and possibly improve, synchronization.

Implementations of the method 1100 may include one or more of the following features. In an example implementation, the device is a second access point that is outside of the synchronization network, and the method further includes: receiving, at the apparatus from one or more of the plurality of first access points, one or more first indications of a respective signal transmission from the second access point; and transmitting, from the apparatus to a selected access point of the plurality of first access points, a second indication for the selected access point to establish a connection with the second access point. For example, at stage 520, the management entity 130 may receive one or more of the report messages 526-528 indicative of one or more WUPs received by one or more of the access points 502-504, and at stage 530 the management entity 130 may transmit the access point connection message 534 to a selected leader access point for an access point to be added to a synchronization network. The processor 210, possibly in combination with the memory 215, in combination with a transceiver (e.g., of the communication component 235) may comprise means for receiving the one or more first indications. This may facilitate addition of a new access point to a synchronization network. The processor 210, possibly in combination with the memory 215, in combination with a transceiver (e.g., of the communication component 235) may comprise means for transmitting the second indication. In a further example implementation, the plurality of first access points includes a root access point, and wherein the selected access point has a fewest number of hops to the root access point of the one or more of the plurality of first access points from which the one or more first indications are received. This may help keep timing drift as low as possible for a new access point of a synchronization network, which may help maintain good synchronization, and thus help conserver processing time and power for receiving an processing signals transmitting from access points in the synchronization network. In a further example implementation, the one or more first indications each indicate at least a threshold reception quality of the respective signal transmission from the second access point. For example, a candidate leader access point may not be considered by the management entity 130 for being a leader access point of a new access point for the synchronization network unless the candidate leader access point received a signal from the new access point with at least a threshold signal quality (e.g., a threshold signal strength). This may help ensure that the new access point will be able to synchronize well with the leader access point. In another example implementation, the respective transmission signal from the second access point comprises a wake-up packet. In another example implementation, the synchronization signal transmission configuration information is configured to assist the second access point to calibrate further signal transmission timing relative to the selected access point. For example, the synchronization signal transmission configuration information may comprise calibration information (e.g., a timing adjustment) for the new access point for transmitting signals, which may help improve synchronization of the new access point and thus the synchronization network (including the new access point).

Also or alternatively, implementations of the method 1100 may include one or more of the following features. In an example implementation, the plurality of first access points includes a root access point, wherein the device is an observer device, and wherein the method further comprises receiving, at the apparatus from the observer device, one or more third indications each indicative of a respective transmission drift between each of the at least one of the plurality of first access points and the root access point. For example, the management entity 130 may receive the observed drift report 932 indicative of relative drift corresponding to one or more of the access points 902-904 (e.g., relative to the root access point 901 and/or relative to a respective leader access point). In a further example implementation, the synchronization signal transmission configuration information comprises one or more fourth indications of the one or more third indications. The one or more fourth indications may comprise transmission drift and/or calibration information (e.g., a timing adjustment). This may help one or more access points in a synchronization network to maintain or even improve synchronization with a leader access point (e.g., a root access point), thus helping conserve processing time and/or power.

### IMPLEMENTATION EXAMPLES

Implementation examples are provided in the following numbered clauses.
Clause 1. An apparatus, for coordinating access point synchronization, comprising:
   a transceiver;
   a memory; and
   a processor, communicatively coupled to the transceiver and the memory, configured to:
      obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
      transmit, via the transceiver for a device that is unsynchronized with the second access point, the synchronization signal transmission configuration information and the synchronization signal transfer role indication.
Clause 2. The apparatus of clause 1, wherein the device is a third access point that is outside of the synchronization network, and wherein the processor is further configured to:
   receive, via the transceiver from one or more of the plurality of access points, one or more first indications of a respective signal transmission from the third access point; and
   transmit, via the transceiver to a selected access point of the plurality of access points, a second indication for the selected access point to establish a connection with the third access point.
Clause 3. The apparatus of clause 2, wherein the plurality of access points includes a root access point, and wherein the selected access point has a fewest number of hops to the root access point of the one or more of the plurality of access points, other than the root access point, from which the one or more first indications are received.
Clause 4. The apparatus of clause 3, wherein the one or more first indications each indicate at least a threshold reception quality of the respective signal transmission from the third access point.
Clause 5. The apparatus of clause 2, wherein the respective transmission signal from the third access point comprises a wake-up packet.
Clause 6. The apparatus of clause 2, wherein the synchronization signal transmission configuration information is configured to assist the third access point to calibrate further signal transmission timing relative to the selected access point.
Clause 7. The apparatus of clause 1, wherein the plurality of access points includes a root access point, wherein the device is an observer device, and wherein the processor is further configured to receive, via the transceiver from the observer device, one or more third indications each indicative of a respective transmission drift between each of at least one of the plurality of access points, other than the root access point, and the root access point.
Clause 8. The apparatus of clause 7, and wherein the synchronization signal transmission configuration information comprises one or more fourth indications of the one or more third indications.
Clause 9. A method, for coordinating access point synchronization, comprising:
   obtaining at an apparatus, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
   transmitting, from the apparatus for a device that is unsynchronized with the second access point, the synchronization signal transmission configuration information and the synchronization signal transfer role indication.
Clause 10. The method of clause 9, wherein the device is a third access point that is outside of the synchronization network, and wherein the method further comprises:
   receiving, at the apparatus from one or more of the plurality of access points, one or more first indications of a respective signal transmission from the third access point; and
   transmitting, from the apparatus to a selected access point of the plurality of access points, a second indication for the selected access point to establish a connection with the third access point.
Clause 11. The method of clause 10, wherein the plurality of access points includes a root access point, and wherein the selected access point has a fewest number of hops to the root access point of the one or more of the plurality of access points, other than the root access point, from which the one or more first indications are received.
Clause 12. The method of clause 11, wherein the one or more first indications each indicate at least a threshold reception quality of the respective signal transmission from the third access point.
Clause 13. The method of clause 10, wherein the respective transmission signal from the third access point comprises a wake-up packet.
Clause 14. The method of clause 10, wherein the synchronization signal transmission configuration information is configured to assist the third access point to calibrate further signal transmission timing relative to the selected access point.
Clause 15. The method of clause 9, wherein the plurality of access points includes a root access point, wherein the device is an observer device, and wherein the method further comprises receiving, at the apparatus from the observer device, one or more third indications each indicative of a respective transmission drift between each of at least one of the plurality of access points, other than the root access point, and the root access point.
Clause 16. The method of clause 15, and wherein the synchronization signal transmission configuration information comprises one or more fourth indications of the one or more third indications.
Clause 17. An apparatus, for coordinating access point synchronization, comprising:
   means for obtaining, for first access point of a plurality of access points of a synchronization network, synchronization signal transmission configuration information and, for a second access point of the plurality of access points, a synchronization signal transfer role indication that the second access point of the plurality of access points is a leader, or a follower, or both; and
   means for transmitting, for a device that is unsynchronized with the second access point, the synchronization signal transmission configuration information and the synchronization signal transfer role indication.
Clause 18. The apparatus of clause 17, wherein the device is a third access point that is outside of the synchronization network, and wherein the apparatus further comprises:
   means for receiving, from one or more of the plurality of access points, one or more first indications of a respective signal transmission from the third access point; and
   means for transmitting, to a selected access point of the plurality of access points, a second indication for the selected access point to establish a connection with the third access point.
Clause 19. The apparatus of clause 18, wherein the plurality of access points includes a root access point, and wherein the selected access point has a fewest number of hops to the root access point of the one or more of the plurality of access points, other than the root access point, from which the one or more first indications are received.
Clause 20. The apparatus of clause 19, wherein the one or more first indications each indicate at least a threshold reception quality of the respective signal transmission from the third access point.
Clause 21. The apparatus of clause 18, wherein the respective transmission signal from the third access point comprises a wake-up packet.
Clause 22. The apparatus of clause 18, wherein the synchronization signal transmission configuration information is configured to assist the third access point to calibrate further signal transmission timing relative to the selected access point.
Clause 23. The apparatus of clause 17, wherein the plurality of access points includes a root access point, wherein the device is an observer device, and wherein the apparatus further comprises means for receiving, from the observer device, one or more third indications each indicative of a respective transmission drift between each of at least one of the plurality of access points, other than the root access point, and the root access point.
Clause 24. The apparatus of clause 23, and wherein the synchronization signal transmission configuration information comprises one or more fourth indications of the one or more third indications.
Clause 25. A non-transitory, processor-readable storage medium comprising processor-readable instructions to cause a processor of an apparatus, for coordinating access point synchronization, to:
   obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
   transmit, for a device that is unsynchronized with the second access point, the synchronization signal transmission configuration information and the synchronization signal transfer role indication.
Clause 26. The non-transitory, processor-readable storage medium of clause 25, wherein the device is a third access point that is outside of the synchronization network, and wherein the non-transitory, processor-readable storage medium further comprises processor-readable instructions to cause the processor to:
   receive, from one or more of the plurality of access points, one or more first indications of a respective signal transmission from the third access point; and
   transmit, to a selected access point of the plurality of access points, a second indication for the selected access point to establish a connection with the third access point.
Clause 27. The non-transitory, processor-readable storage medium of clause 26, wherein the plurality of access points includes a root access point, and wherein the selected access point has a fewest number of hops to the root access point of the one or more of the plurality of access points, other than the root access point, from which the one or more first indications are received.
Clause 28. The non-transitory, processor-readable storage medium of clause 27, wherein the one or more first indications each indicate at least a threshold reception quality of the respective signal transmission from the third access point.
Clause 29. The non-transitory, processor-readable storage medium of clause 26, wherein the respective transmission signal from the third access point comprises a wake-up packet.
Clause 30. The non-transitory, processor-readable storage medium of clause 26, wherein the synchronization signal transmission configuration information is configured to assist the third access point to calibrate further signal transmission timing relative to the selected access point.
Clause 31. The non-transitory, processor-readable storage medium of clause 25, wherein the plurality of access points includes a root access point, wherein the device is an observer device, and wherein the non-transitory, processor-readable storage medium further comprises processor-readable instructions to cause the processor to receive, from the observer device, one or more third indications each indicative of a respective transmission drift between each of at least one of the plurality of access points, other than the root access point, and the root access point.
Clause 32. The non-transitory, processor-readable storage medium of clause 31, and wherein the synchronization signal transmission configuration information comprises one or more fourth indications of the one or more third indications.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus, for coordinating access point synchronization, comprising:
a transceiver;
a memory; and
a processor, communicatively coupled to the transceiver and the memory, configured to:
obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
transmit, via the transceiver for a device that is unsynchronized with the second access point, the synchronization signal transmission configuration information and the synchronization signal transfer role indication.

2. The apparatus of claim 1, wherein the device is a third access point that is outside of the synchronization network, and wherein the processor is further configured to:
receive, via the transceiver from one or more of the plurality of access points, one or more first indications of a respective signal transmission from the third access point; and
transmit, via the transceiver to a selected access point of the plurality of access points, a second indication for the selected access point to establish a connection with the third access point.

3. The apparatus of claim 2, wherein the plurality of access points includes a root access point, and wherein the selected access point has a fewest number of hops to the root access point of the one or more of the plurality of access points, other than the root access point, from which the one or more first indications are received.

4. The apparatus of claim 3, wherein the one or more first indications each indicate at least a threshold reception quality of the respective signal transmission from the third access point.

5. The apparatus of claim 2, wherein the respective transmission signal from the third access point comprises a wake-up packet.

6. The apparatus of claim 2, wherein the synchronization signal transmission configuration information is configured to assist the third access point to calibrate further signal transmission timing relative to the selected access point.

7. The apparatus of claim 1, wherein the plurality of access points includes a root access point, wherein the device is an observer device, and wherein the processor is further configured to receive, via the transceiver from the observer device, one or more third indications each indicative of a respective transmission drift between each of at least one of the plurality of access points, other than the root access point, and the root access point.

8. The apparatus of claim 7, and wherein the synchronization signal transmission configuration information comprises one or more fourth indications of the one or more third indications.

9. A method, for coordinating access point synchronization, comprising:
obtaining at an apparatus, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
transmitting, from the apparatus for a device that is unsynchronized with the second access point, the synchronization signal transmission configuration information and the synchronization signal transfer role indication.

10. The method of claim 9, wherein the device is a third access point that is outside of the synchronization network, and wherein the method further comprises:
receiving, at the apparatus from one or more of the plurality of access points, one or more first indications of a respective signal transmission from the third access point; and
transmitting, from the apparatus to a selected access point of the plurality of access points, a second indication for the selected access point to establish a connection with the third access point.

11. The method of claim 10, wherein the plurality of access points includes a root access point, and wherein the selected access point has a fewest number of hops to the root access point of the one or more of the plurality of access points, other than the root access point, from which the one or more first indications are received.

12. The method of claim 11, wherein the one or more first indications each indicate at least a threshold reception quality of the respective signal transmission from the third access point.

13. The method of claim 10, wherein the respective transmission signal from the third access point comprises a wake-up packet.

14. The method of claim 10, wherein the synchronization signal transmission configuration information is configured to assist the third access point to calibrate further signal transmission timing relative to the selected access point.

15. The method of claim 9, wherein the plurality of access points includes a root access point, wherein the device is an observer device, and wherein the method further comprises receiving, at the apparatus from the observer device, one or more third indications each indicative of a respective transmission drift between each of at least one of the plurality of access points, other than the root access point, and the root access point.

16. The method of claim 15, and wherein the synchronization signal transmission configuration information comprises one or more fourth indications of the one or more third indications.

17. An apparatus, for coordinating access point synchronization, comprising:
means for obtaining, for first access point of a plurality of access points of a synchronization network, synchronization signal transmission configuration information and, for a second access point of the plurality of access points, a synchronization signal transfer role indication that the second access point of the plurality of access points is a leader, or a follower, or both; and
means for transmitting, for a device that is unsynchronized with the second access point, the synchronization signal transmission configuration information and the synchronization signal transfer role indication.

18. The apparatus of claim 17, wherein the device is a third access point that is outside of the synchronization network, and wherein the apparatus further comprises:
means for receiving, from one or more of the plurality of access points, one or more first indications of a respective signal transmission from the third access point; and
means for transmitting, to a selected access point of the plurality of access points, a second indication for the selected access point to establish a connection with the third access point.

19. The apparatus of claim 18, wherein the plurality of access points includes a root access point, and wherein the selected access point has a fewest number of hops to the root access point of the one or more of the plurality of access points, other than the root access point, from which the one or more first indications are received.

20-24. (canceled)

25. A non-transitory, processor-readable storage medium comprising processor-readable instructions to cause a processor of an apparatus, for coordinating access point synchronization, to:
obtain, for a first access point of a plurality of access points of a synchronization network, synchronization signal transmission configuration information and, for a second access point of the plurality of access points, a synchronization signal transfer role indication that the second access point of the plurality of access points is a leader, or a follower, or both; and
transmit, for a device that is unsynchronized with the second access point, the synchronization signal transmission configuration information and the synchronization signal transfer role indication.

26-32. (canceled)
